(19) United States
(12) Patent Application Publication
(10) Pub. No.: US 2026/0112385 A1
(43) Pub. Date: Apr. 23, 2026

(54) METHOD AND APPARATUS FOR ADJUSTING LOUDNESS OF SYNTHESIZED VOCAL AUDIO, DEVICE, AND PRODUCT

(71) Applicant: Beijing Zitiao Network Technology Co., Ltd., Beijing (CN)

(72) Inventors: Shichao GE, Beijing (CN); Jin HUANG, Beijing (CN)

(21) Appl. No.: 19/304,299

(22) Filed: Aug. 19, 2025

(30) Foreign Application Priority Data
Oct. 17, 2024 (CN) 202411455602.6

(51) Int. Cl. G10L 21/034; G10L 25/78; H04S 1/00; H04S 7/00

(52) U.S. Cl. CPC G10L 21/034; G10L 25/78; H04S 1/007; H04S 7/305

(57) ABSTRACT

The present disclosure relates to a method and an apparatus for adjusting the loudness of synthesized vocal audio, a device, and a product. The method includes determining a first loudness curve of original vocal audio and a second loudness curve of the synthesized vocal audio, where the original vocal audio is wet audio, and the loudness curve indicates changes in an amplitude of sound over time. The method further includes adjusting the second loudness curve based on the first loudness curve. In addition, the method further includes adjusting the loudness of the synthesized vocal audio based on the adjusted second loudness curve.

### CROSS-REFERENCE TO RELATED APPLICATION(S)

This application claims priority to Chinese Application No. 202411455602.6 filed Oct. 17, 2024, the disclosure of which is incorporated herein by reference in its entirety.

### FIELD

The present disclosure relates to the field of computers, and more particularly, to a method and an apparatus for adjusting the loudness of synthesized vocal audio, a device, and a product.

### BACKGROUND

Synthesized vocal audio refers to similar vocals with new content or characteristics that are generated by analyzing and processing original vocal samples using computer technologies or audio software.

In recent years, with the rapid development of deep learning technologies, vocal synthesis methods based on deep neural network models have gradually replaced methods based on conventional digital signal processing, and has become the mainstream for the generation of synthesized vocal audio. These methods include speech synthesis systems based on models such as generative adversarial networks (GANs), recurrent neural networks (RNNs), and convolutional neural networks (CNNs). These models can generate realistic vocals by learning feature representations and generation patterns from a large amount of speech data.

### SUMMARY

According to a first aspect of embodiments of the present disclosure, a method for adjusting the loudness of synthesized vocal audio is provided. The method includes determining a first loudness curve of original vocal audio and a second loudness curve of the synthesized vocal audio, where the original vocal audio is wet audio, and the loudness curve indicates changes in an amplitude of sound over time. The method further includes adjusting the second loudness curve based on the first loudness curve. In addition, the method further includes adjusting the loudness of the synthesized vocal audio based on the adjusted second loudness curve.

According to a second aspect of embodiments of the present disclosure, an apparatus for adjusting the loudness of synthesized vocal audio is provided. The apparatus includes a curve determination module configured to determine a first loudness curve of original vocal audio and a second loudness curve of the synthesized vocal audio, where the original vocal audio is wet audio, and the loudness curve indicates changes in an amplitude of sound over time. The apparatus further includes a curve adjustment module configured to adjust the second loudness curve based on the first loudness curve. In addition, the apparatus further includes a loudness adjustment module configured to adjust the loudness of the synthesized vocal audio based on the adjusted second loudness curve.

According to a third aspect of embodiments of the present disclosure, an electronic device is provided. The electronic device includes one or more processors; and a storage apparatus configured to store one or more programs, where the one or more programs, when executed by the one or more processors, cause the one or more processors to implement a method for adjusting the loudness of synthesized vocal audio. The method includes determining a first loudness curve of original vocal audio and a second loudness curve of the synthesized vocal audio, where the original vocal audio is wet audio, and the loudness curve indicates changes in an amplitude of sound over time. The method further includes adjusting the second loudness curve based on the first loudness curve. In addition, the method further includes adjusting the loudness of the synthesized vocal audio based on the adjusted second loudness curve.

According to a fourth aspect of embodiments of the present disclosure, a computer program product is provided. The computer program product is tangibly stored on a non-transitory computer-readable medium and includes machine-executable instructions that, when executed, cause a machine to implement a method for adjusting the loudness of synthesized vocal audio. The method includes determining a first loudness curve of original vocal audio and a second loudness curve of the synthesized vocal audio, where the original vocal audio is wet audio, and the loudness curve indicates changes in an amplitude of sound over time. The method further includes adjusting the second loudness curve based on the first loudness curve. In addition, the method further includes adjusting the loudness of the synthesized vocal audio based on the adjusted second loudness curve.

The SUMMARY OF THE INVENTION section is provided to introduce a selection of concepts in a simplified form, which will be further described in the detailed description below. The SUMMARY OF THE INVENTION section is neither intended to identify key features or principal features of the claimed subject matter, nor to limit the scope of the claimed subject matter.

### BRIEF DESCRIPTION OF THE DRAWINGS

The foregoing and other features, advantages and aspects of embodiments of the present disclosure become more apparent with reference to the following detailed description and in conjunction with the accompanying drawings. Throughout the accompanying drawings, the same or similar reference numerals denote the same or similar elements, in which:

FIG. 1 illustrates a schematic diagram of an example environment in which a plurality of embodiments of the present disclosure can be implemented;

FIG. 2 illustrates a flowchart of a method for adjusting the loudness of synthesized vocal audio according to some embodiments of the present disclosure;

FIG. 3 illustrates a schematic diagram of an example process of mixing synthesized vocal audio with accompaniment audio according to some embodiments of the present disclosure;

FIG. 4 illustrates a schematic diagram of an example of calibrating stereo sound envelope loudness according to some embodiments of the present disclosure;

FIG. 5 illustrates a block diagram of an apparatus for adjusting the loudness of synthesized vocal audio according to some embodiments of the present disclosure; and

FIG. 6 illustrates a block diagram of a device capable of implementing a plurality of embodiments of the present disclosure.

### DETAILED DESCRIPTION OF EMBODIMENTS

It can be understood that all user-related data involved in the technical solutions should be obtained and used with the authorization of the user. It means that in the technical solutions, if personal information of the user needs to be used, explicit consent and authorization of the user are required before the data is obtained, otherwise the collection and use of the related data will be disallowed. It should also be understood that during implementation of the technical solutions, the collection, use, and storage of data should strictly comply with relevant laws and regulations, necessary technologies and measures should be used to ensure the security of the user data and ensure safe use of the data.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, upon reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, and the like may refer to different objects or the same object, unless otherwise explicitly defined. Other explicit and implicit definitions may be included below.

As described above, synthesized vocal audio has a wide range of applications. For example, in the field of intelligent cover song production, synthesized vocal audio may be used to convert an original song into cover versions with personalized characteristics. Typically, in music production, songs are mainly re-covered by professional music producers through conventional methods. Although such a method works well, it requires significant investment and suffers from low production efficiency. In the related art, although a certain degree of similarity between synthesized vocals and vocals in the original song in details can be achieved, compared to the vocals in the original song, the synthesized vocals are hardly satisfactory in terms of loudness consistency with the original audio, reducing the overall appeal of the musical work. To this end, the present disclosure provides a method for dynamically adjusting the loudness of synthesized vocal audio based on the loudness of vocals of the original song. In the solution according to the present disclosure, by analyzing the loudness curve of vocal audio of the original song and adjusting the loudness curve of synthesized vocal audio based on the loudness curve of the vocal audio of the original song, the loudness of the synthesized vocal audio can be matched to the loudness of the vocal audio of the original song, which ensures that the synthesized vocals and the vocals of the original song are consistent in richness of loudness details, thereby improving the listeners' auditory experience.

It should be understood that the technical solutions of the present disclosure are implemented with the permission of relevant parties as permitted by laws and regulations. For example, in the field of intelligent cover song production, the solutions are implemented under licensing for the copyrighted songs being covered.

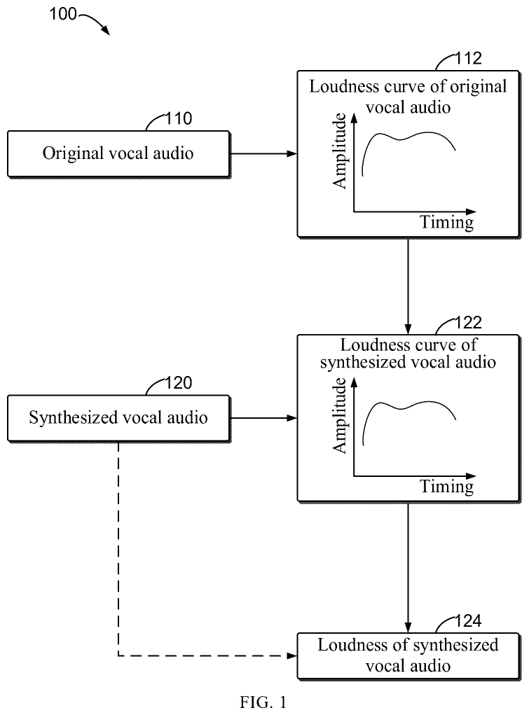

FIG. 1 illustrates a schematic diagram of an example environment 100 in which a plurality of embodiments of the present disclosure can be implemented. To ensure that the synthesized vocal audio, after superimposed with the accompaniment audio of the original song, can achieve an effect close to that of the vocal audio of the original song being superimposed with the accompaniment, it is necessary to ensure that the synthesized vocal audio and the original vocal audio are consistent in loudness performance. Here, loudness mainly depends on factors such as sound intensity (amplitude) and frequency, which is a subjective perception of humans. Loudness matching enables the synthesized vocal audio to be more acoustically harmonized with the original song. To ensure that the synthesized vocal audio and the original vocal audio are consistent in loudness, the loudness curve of the synthesized vocal audio may be adjusted to make the two consistent. This is because the loudness curve covers the temporal range of the entire audio and can reflect variations in the loudness of the audio across different time periods.

As shown in FIG. 1, a loudness curve 112 of original vocal audio and a loudness curve 122 of synthesized vocal audio may be respectively obtained based on original audio 110 and synthesized vocal audio 120. In some embodiments, the loudness curve 112 of the original vocal audio and the loudness curve of the synthesized vocal audio may be separately obtained by using a polynomial fitting method. In some embodiments, the original vocal audio 110 is wet audio, that is, post-processed vocal audio. Common post-processing includes reverberation, delay, chorus, and the like. These effects make sound be richer, more spatial and more stereoscopic. In contrast to wet audio is dry audio, which refers to an original vocal signal that has not been processed by any effect, that is, wet audio may be obtained by adding various effects to dry audio.

Referring to FIG. 1, after the loudness curves of the two pieces of audio are obtained separately, to ensure that the loudness curve 122 of the synthesized vocal audio can be kept matched with the loudness curve 112 of the original vocal audio, the loudness curve 122 of the synthesized vocal audio may be adjusted based on the loudness curve 112 of the original vocal audio, that is, the loudness curve 122 of the synthesized vocal audio is adjusted in amplitude, for example, the amplitude at a certain time point may be increased or decreased to be consistent with an amplitude of the original vocal audio 110 at this time point. In some embodiments, a gain factor may be calculated by comparing the loudness curves of the two audios, so that the loudness curve 112 of the synthesized vocal audio can be adjusted based on the gain factor. In some embodiments, to avoid adding noise to a silent segment of the synthesized vocal audio 120, the gain factor of the silent segment of the synthesized vocal audio 120 may be set to 0.

Still referring to FIG. 1, after the loudness curve 122 of the synthesized vocal audio is adjusted based on the loudness curve 112 of the original vocal audio, it can be ensured that the loudness 124 of the synthesized vocal audio is matched to the loudness of the original vocal audio. To ensure that the loudness curves of the two can be correctly matched, a time delay may be further calculated to ensure that signals of the two can be aligned in time.

Through this method for dynamically adjusting the loudness of the synthesized vocal audio by means of the loudness curve, the synthesized vocal audio can have the same loudness as the original audio, which improves the overall appeal of the synthesized vocal audio, thereby improving the user experience.

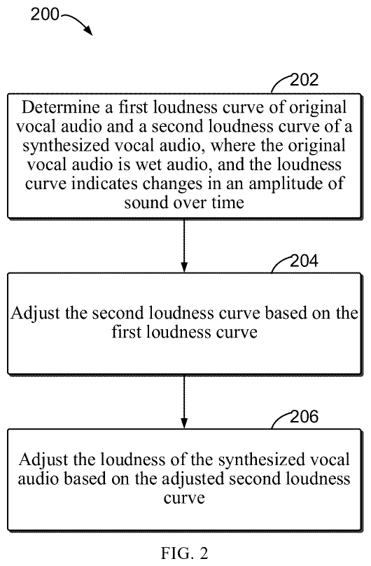

FIG. 2 illustrates a flowchart of a method 200 for adjusting the loudness of synthesized vocal audio according to some embodiments of the present disclosure. The method 200 may be performed by an apparatus for adjusting the loudness of synthesized vocal audio. As shown in FIG. 2, the method 200 includes block 202, block 204, and block 206.

At block 202, a first loudness curve of original vocal audio and a second loudness curve of synthesized vocal audio are determined, where the original vocal audio is wet audio, and the loudness curve indicates changes in an amplitude of sound over time. To ensure that the synthesized vocal audio and the original vocal audio are consistent in loudness, the loudness curve of the synthesized vocal audio may be adjusted to make the two consistent. This is because the loudness curve covers the temporal range of the entire audio and can reflect variations in the loudness of the audio over different time periods. Referring to FIG. 1, the loudness curve 112 of the original vocal audio and the loudness curve 122 of the synthesized vocal audio may be respectively obtained based on the original audio 110 and the synthesized vocal audio 120. In some embodiments, the loudness curve 112 of the original vocal audio and the loudness curve of the synthesized vocal audio may be separately obtained by using a polynomial fitting method. In some embodiments, the original vocal audio 110 is wet audio, that is, post-processed vocal audio. Common post-processing includes reverberation, delay, chorus, and the like. These effects make sound be richer, more spatial and more stereoscopic.

At block 204, the second loudness curve is adjusted based on the first loudness curve. Referring to FIG. 1, after the loudness curves of the two pieces of audio are obtained separately, to ensure that the loudness curve 122 of the synthesized vocal audio can be kept matched with the loudness curve 112 of the original vocal audio, the loudness curve 122 of the synthesized vocal audio may be adjusted based on the loudness curve 112 of the original vocal audio, that is, the loudness curve 122 of the synthesized vocal audio is adjusted in amplitude, for example, the amplitude at a certain time point may be increased or decreased to be consistent with an amplitude of the original vocal audio 110 at this time point. In some embodiments, a gain factor may be calculated by comparing the loudness curves of the two audios, so that the loudness curve 112 of the synthesized vocal audio can be adjusted based on the gain factor.

At block 206, the loudness of the synthesized vocal audio is adjusted based on the adjusted second loudness curve. Referring to FIG. 1, after the loudness curve 122 of the synthesized vocal audio is adjusted based on the loudness curve 112 of the original vocal audio, it can be ensured that the loudness 124 of the synthesized vocal audio is matched to the loudness of the original vocal audio. In some embodiments, to ensure that the loudness curves of the two audios can be correctly matched, a time delay may be further calculated to ensure that signals of the two can be aligned in time.

By analyzing the loudness curve of the vocal audio of the original song, and adjusting the loudness curve of the synthesized vocal audio based on the loudness curve of the vocal audio of the original song, the loudness of the synthesized vocal audio can be matched to the loudness of the vocal audio of the original song, which ensures that synthesized vocals and vocals of the original song are consistent in richness of loudness details, thereby improving listeners' experience.

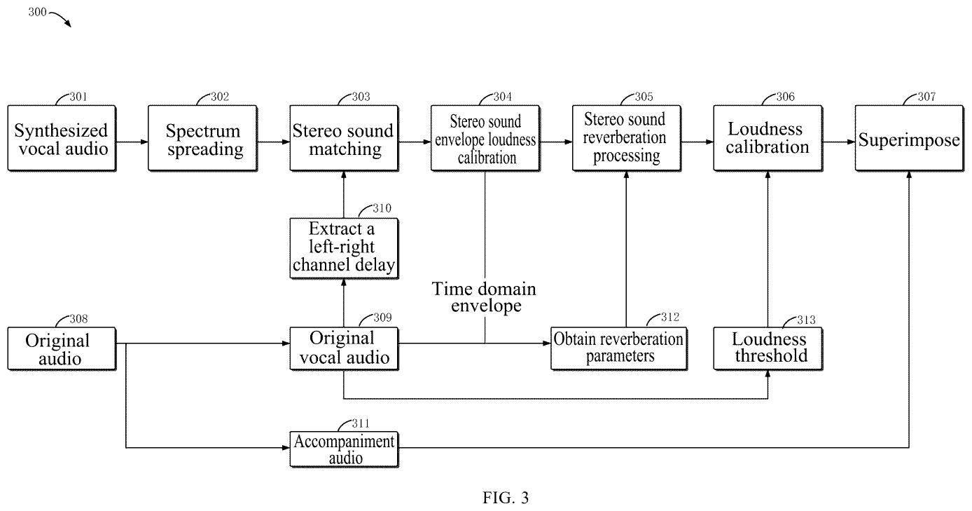

FIG. 3 illustrates a schematic diagram of an example process 300 of mixing synthesized vocal audio with accompaniment audio according to some embodiments of the present disclosure. To enable cover audio with artificially synthesized vocals to be matched to accompaniment of the original song, the synthesized vocal audio of the cover song may be adjusted in accordance with the envelope loudness of vocal audio of the original song. Referring to FIG. 3, to obtain original vocal audio 309 of original audio 308, the original vocal audio 309 and accompaniment audio 311 may be separated by using a music source separation (MSS) technique. It can be understood that there are a variety of methods to separate the original vocal audio and the accompaniment audio from the original audio, which is not limited in the present disclosure.

Still referring to FIG. 3, to make the synthesized vocal audio 301 have the same stereo sound effect as the original vocal audio 309, that is, to enhance layering of the synthesized vocal audio 301, stereo sound may be matched at 303. Before performing stereo sound effect matching, digital signal processing (DSP) spectrum spreading may be first performed on the synthesized vocal audio at 302, which can avoid deficiencies of the synthesized vocal audio 301 in certain frequency ranges. For example, the synthesized vocal audio 301 may lack high-frequency components and appear to be not clear enough, or lack low-frequency components and appear to lack vocal details. To ensure the smooth performing of a stereo sound matching process at 303, a left-right channel delay of the original vocal audio 309 may be first extracted at 310, and the extracted left-right channel delay may be applied to the stereo sound matching process at 303, which can better ensure that the synthesized vocal audio 301 and the original vocal audio 309 are consistent, thereby improving listeners' spatial experience. It can be understood that the audio herein used to extract the left-right channel delay may be dry audio of the original vocal audio 309.

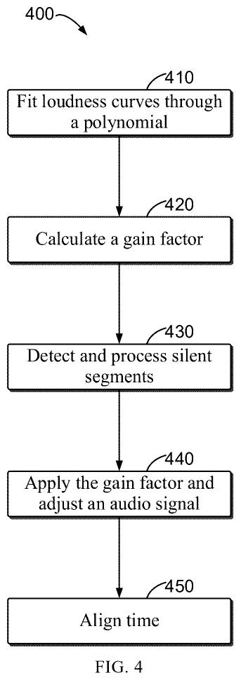

Still referring to FIG. 3, after the synthesized vocal audio 301 and the original vocal audio 309 are matched in stereo sound, stereo sound envelope loudness calibration may be performed at 304 to ensure loudness consistency of the two. In some embodiments, the loudness curve of the synthesized vocal audio 301 may be adjusted to be matched to the loudness of the original vocal audio. Description will be provided below in conjunction with FIG. 4. FIG. 4 illustrates a schematic diagram of an example 400 of calibrating the stereo sound envelope loudness according to some embodiments of the present disclosure. As shown in FIG. 4, at 410, loudness curves are fitted through a polynomial, that is, a loudness curve of original vocal audio 309 and a loudness curve of synthesized vocal audio 301 that are fitted may be respectively obtained based on the original vocal audio and the synthesized vocal audio. In some embodiments, absolute amplitudes of the original vocal audio 309 and the synthesized vocal audio 301 may be separately extracted, and these amplitude values may be then processed by using a polynomial fitting method. In some embodiments, a calculation formula for polynomial fitting may be as follows:

$$p = Polynomial . fit ( x , y , deg ) \qquad ( 1 )$$

In formula (1), x is a time sequence of data points, representing different time points. y is an absolute amplitude of an audio signal. deg is a polynomial degree that determines the complexity of fitting curves. A continuous loudness curve formed through fitting based on formula (1) can better reflect a change trend of the loudness of the audio over time.

After the loudness curves of the two pieces of audio are obtained separately, to ensure that the loudness curve of the synthesized vocal audio can be kept matched with the loudness curve of the original vocal audio, the loudness curve of the synthesized vocal audio may be adjusted based on the loudness curve of the original vocal audio, that is, the loudness curve of the synthesized vocal audio is adjusted in amplitude. Still referring to FIG. 4, at 420, a gain factor may be calculated. In some embodiments, the gain factor may be calculated by comparing the loudness curves of the two, so that the loudness curve of the synthesized vocal audio 301 after stereo sound matching may be adjusted based on the gain factor and by using the original vocal audio 309 as a reference. In some embodiments, a calculation formula for the gain factor may be as follows:

$$gain\_factors = \frac{wet\_envelope \_smooth}{synth\_envelope \_smooth + ϵ} \qquad ( 2 )$$

In formula (2), e is a small constant, used to prevent a denominator from being 0.synth_envelope_smooth is a loudness curve of the synthesized vocal audio after smoothing, and wet_envelpoe_smooth is a loudness curve of the original vocal audio after smoothing. Based on formula (2), the gain factor can be calculated, where the gain factor represents a proportion that the synthesized vocal audio 301 needs to be adjusted at each time point relative to the original vocal audio.

In conjunction with FIG. 4, detection and processing of a silent segment may be performed at 430, to avoid unnecessary adjustments to the silent segment of the synthesized vocal audio 301, thereby reducing noise and distortion in the synthesized vocal audio. For example, the silent segment in a signal may be determined by using a function, so that the gain factor of the silent segment can be set to 0, which can ensure that the signal of the silent segment is not processed. In some embodiments, a formula for determining the function for the silent segment may be as follows:

$$silence\_segments = find\_segments ( signal , threshold , min\_duration , sample\_rate ) \qquad ( 3 )$$

In formula (3), the silent segment may be identified based on a threshold threshold and minimum duration min_duration.

In conjunction with FIG. 4, after the gain factor is determined, at 440, the gain factor may be applied to adjust the loudness curve of the synthesized vocal audio, so that the synthesized vocal audio 301 and the original vocal audio 309 can tend to be matched in loudness. In some embodiments, a calculation formula for adjusting the loudness curve of the synthesized vocal audio 301 is as follows:

$$adjusted\_signal = synth\_vocal \times gain\_factors \qquad ( 4 )$$

Based on formula (4), the loudness of the synthesized vocal audio 301 may be adjusted based on the gain factor, so that the two audios can be matched in loudness. In a process of adjusting the loudness of the synthesized vocal audio, it is further necessary to ensure that a phase of the original vocal audio used as the reference and a phase of the synthesized vocal audio are kept consistent, so that vocal distortion or disharmony caused by the different phases can be avoided. In conjunction with FIG. 4, time may be aligned at 450. In some embodiments, a time delay may be calculated using generalized cross-correlation with phase transform (GCC-PHAT), and a calculation formula is as follows:

$$t a u = gccphat ( synthetic\_signal , wet\_signal , sr , max\_tau , interp ) \qquad ( 5 )$$

where synthetic_signal is a signal of the synthesized vocal audio, wet_signal is a signal of the original vocal audio, max_tau is a search range of a maximum time delay, sr is a sampling rate, and interp is an interpolation method. Based on formula (5), a delay tau between the two signals can be calculated.

In some embodiments, after the delay tau between the two signals is calculated, the time delay tau may be multiplied by the sampling rate sr based on the following formula (6), and rounded off to obtain a sample lag of the time delay. Time alignment of the synthesized vocal audio and the original vocal audio is then implemented based on the sample lag of the delay, so that the two audio signals are synchronized in time.

$$lag = int ( t a u \times s r ) \qquad ( 6 )$$

According to the method for dynamically adjusting the loudness of the synthesized vocal audio based on the loudness curve, the synthesized vocal audio can have the same loudness as the original audio, which improves the overall appeal of the synthesized vocal audio, thereby improving the user experience.

Returning to FIG. 3, after the loudness curve of the synthesized vocal audio 301 is adjusted based on the loudness curve of the original vocal audio 309 in a time domain, to make the synthesized vocal audio 301 have reverberation effects close to those of the original vocal audio 309, stereo sound reverberation processing may be performed on the synthesized vocal audio 301 at 305. To ensure that the reverberation effects of the synthesized vocal audio 301 are harmonious and consistent with those of the original vocal audio 309, reverberation parameters of the original vocal audio 309 may be extracted at 312, so that the synthesized vocal audio after stereo sound envelope loudness calibration may be adjusted based on the reverberation parameters. In some embodiments, the reverberation parameters may be reverberation time, may be a ratio of dry sound to reverberation, or may be parameters that can affect the reverberation effects, such as early reflection time.

Still referring to FIG. 3, when the reverberation parameters obtained at 312 are applied to perform stereo sound reverberation processing on the synthesized vocal audio 301 at 305, to ensure the coordination in the overall loudness of the synthesized vocal audio 301, the loudness may be globally calibrated at 306. In some embodiments, the overall loudness of the synthesized vocal audio 301 may be adjusted by using a predetermined loudness threshold 313. In some embodiments, the loudness threshold 313 may be determined based on the original vocal audio 309.

As shown in FIG. 3, after stereo sound matching, stereo sound envelope calibration, stereo sound reverberation processing, and loudness calibration processing are performed on the synthesized vocal audio 301, the processed synthesized vocal audio may be superimposed with the accompaniment audio 311 of the original audio 308 at 307, so that a cover version of the original audio 308 based on the synthesized vocal audio 301 can be obtained.

Through this method, the loudness and dynamic range of cover vocals can be effectively adjusted, so that the cover vocals are better fused with background music, that is, half-axis audio 311. Therefore, overall expressiveness and auditory quality of the musical work based on the cover song with synthesized vocals can be improved, and listeners' auditory experience can be further improved.

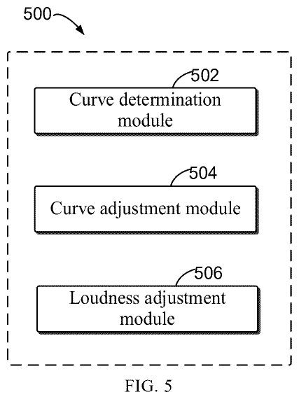

FIG. 5 illustrates a block diagram of an apparatus 500 for adjusting the loudness of synthesized vocal audio according to some embodiments of the present disclosure. As shown in FIG. 5, the apparatus 500 includes a curve determination module 502 configured to determine a first loudness curve of original vocal audio and a second loudness curve of the synthesized vocal audio, where the original vocal audio is wet audio, and the loudness curve indicates changes in an amplitude of sound over time. The apparatus 500 further includes a curve adjustment module 504 configured to adjust the second loudness curve based on the first loudness curve. In addition, the apparatus 500 further includes a loudness adjustment module 506 configured to adjust the loudness of the synthesized vocal audio based on the adjusted second loudness curve.

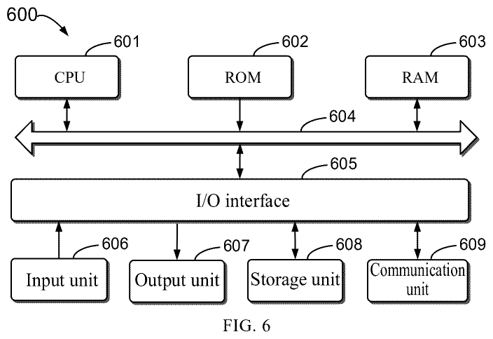

FIG. 6 illustrates a block diagram of a device 600 capable of implementing a plurality of embodiments of the present disclosure. As shown in FIG. 6, the device 600 includes a central processing unit (CPU) and/or graphics processing unit (GPU) 601 that may perform a variety of appropriate actions and processing in accordance with computer program instructions stored in a read-only memory (ROM) 602 or computer program instructions loaded from a storage unit 608 into a random-access memory (RAM) 603. The RAM 603 may further store various programs and data required for the operation of the device 600. The CPU/GPU 601, the ROM 602, and the RAM 603 are connected to each other via a bus 604. An input/output (I/O) interface 605 is also connected to the bus 604. Although not shown in FIG. 6, the device 600 may further include a coprocessor.

A number of components in the device 600 are connected to the I/O interface 605, including: an input unit 606, such as a keyboard or a mouse; an output unit 607, such as various types of displays or speakers; the storage unit 608, such as a magnetic disk or an optical disc; and a communication unit 609, such as a network card, a modem, or a wireless communication transceiver. The communication unit 609 allows the device 600 to exchange information/data with other devices over a computer network such as the Internet and/or various telecommunication networks.

Each method or process described above may be performed by the CPU/GPU 601. For example, in some embodiments, the method may be implemented as a computer software program tangibly embodied in a machine-readable medium, such as the storage unit 608. In some embodiments, some or all of the computer programs may be loaded into and/or installed onto the device 600 via the ROM 602 and/or the communication unit 609. When the computer program is loaded into the RAM 603 and executed by the CPU/GPU 601, one or more steps or actions in the method or process described above may be performed.

In some embodiments, the methods and processes described above may be implemented as a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random-access memory (RAM), a read-only memory (ROM), an erasable programmable read-only memory (EPROM) (or a flash memory), a static random-access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used herein is not to be interpreted as a transient signal, such as a radio wave or another freely propagating electromagnetic wave, an electromagnetic wave propagating through a waveguide or another transmission medium (e.g., an optical pulse through a fiber-optic cable), or an electrical signal transmitted over a wire.

The computer-readable program instructions described herein may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (for example, connected through the Internet with the aid of an Internet service provider). In some embodiments, an electronic circuit, such as a programmable logic circuit, a field programmable gate array (FPGA), or a programmable logic array (PLA), is personalized by using state information of the computer-readable program instructions. The electronic circuit may execute the computer-readable program instructions to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or the other programmable data processing apparatus, create an apparatus for implementing functions/actions specified in one or more blocks in the flowchart and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowchart and/or the block diagrams.

The flowcharts and the block diagrams in the accompanying drawings illustrate possible system architectures, functions, and operations of the device, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions tokenized in the blocks may occur in a sequence different from that tokenized in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

Various embodiments of the present disclosure have been described above. The foregoing descriptions are exemplary, not exhaustive, and are not limited to the disclosed embodiments. Many modifications and variations are apparent to a person of ordinary skill in the art without departing from the scope and spirit of the described embodiments. The terminology used in this specification is intended to best explain the principles, practical applications, or technical improvements in the market of the embodiments, or to enable others of ordinary skill in the art to understand the embodiments disclosed herein.

Some example implementations of the present disclosure are listed below.
Example 1. A method for adjusting the loudness of synthesized vocal audio, comprising:
determining a first loudness curve of original vocal audio and a second loudness curve of the synthesized vocal audio, where the original vocal audio is wet audio, and the loudness curve indicates changes in an amplitude of sound over time;
adjusting the second loudness curve based on the first loudness curve; and
adjusting the loudness of the synthesized vocal audio based on the adjusted second loudness curve.
Example 2. The method according to Example 1, where the determining a first loudness curve of original vocal audio and a second loudness curve of the synthesized vocal audio comprises:
determining absolute amplitudes of the original vocal audio and the synthesized vocal audio;
fitting the absolute amplitudes of the original vocal audio and the synthesized vocal audio through a polynomial; and
determining the first loudness curve and the second loudness curve based on the fitted absolute amplitudes of the original vocal audio and the synthesized vocal audio.
Example 3. The method according to any one of Examples 1 and 2, where the adjusting the second loudness curve based on the first loudness curve comprises:
determining a gain factor based on the first loudness curve and the second loudness curve; and
adjusting the second loudness curve based on the gain factor.
Example 4. The method according to any one of Examples 1 to 3, further comprising:
detecting silent segments of the original vocal audio and the synthesized vocal audio; and
adjusting the gain factor of the silent segment in response to detecting the silent segment.
Example 5. The method according to any one of Examples 1 to 4, where the adjusting the loudness of the synthesized vocal audio based on the adjusted second loudness curve comprises:
determining a time delay between the original vocal audio and the synthesized vocal audio; and
aligning the synthesized vocal audio and the original vocal audio temporally based on the delay.
Example 6. The method according to any one of Examples 1 to 5, further comprising:
determining dry audio of the original vocal audio based on the original vocal audio;
determining a left-right channel delay of the dry audio based on the dry audio; and
adjusting stereo sound of the synthesized vocal audio based on the left-right channel delay.
Example 7. The method according to any one of Examples 1 to 6, further comprising:
determining reverberant audio of the original vocal audio based on the original vocal audio;
determining reverberation parameters based on the reverberant audio, wherein the reverberation parameters indicate effects of the reverberant audio; and
adjusting reverberation of the adjusted stereo sound of the synthesized vocal audio based on the reverberation parameters.
Example 8. The method according to any one of Examples 1 to 7, further comprising:
globally calibrating the loudness of the synthesized vocal audio based on a predetermined threshold.
Example 9. The method according to any one of Examples 1 to 8, further comprising:
obtaining original audio, where the original audio comprises the original vocal audio and accompaniment audio; and
superimposing the accompaniment audio and the synthesized vocal audio whose loudness has been calibrated.
Example 10. An apparatus for adjusting the loudness of synthesized vocal audio, comprising:
a curve determination module configured to determine a first loudness curve of original vocal audio and a second loudness curve of the synthesized vocal audio, where the original vocal audio is wet audio, and the loudness curve indicates changes in an amplitude of sound over time;
a curve adjustment module configured to adjust the second loudness curve based on the first loudness curve; and
a loudness adjustment module configured to adjust the loudness of the synthesized vocal audio based on the adjusted second loudness curve.
Example 11. The apparatus according to Example 10, where the curve determination module comprises:
a first determination module configured to determine absolute amplitudes of the original vocal audio and the synthesized vocal audio;
a fitting module configured to fit the absolute amplitudes of the original vocal audio and the synthesized vocal audio through a polynomial; and
a second determination module configured to determine the first loudness curve and the second loudness curve based on the fitted absolute amplitudes of the original vocal audio and the synthesized vocal audio.
Example 12. The apparatus according to any one of Examples 10 and 11, where the curve adjustment module comprises:
a third determination module configured to determine a gain factor based on the first loudness curve and the second loudness curve; and
a first adjustment module configured to adjust the second loudness curve based on the gain factor.
Example 13. The apparatus according to any one of Examples 10 to 12, further comprising:
a detection module configured to detect silent segments of the original vocal audio and the synthesized vocal audio; and
a second adjustment module configured to adjust the gain factor of the silent segment in response to detecting the silent segment.
Example 14. The apparatus according to any one of Examples 10 to 13, where the loudness adjustment module comprises:
a fourth determination module configured to determine a time delay between the original vocal audio and the synthesized vocal audio; and
an alignment module configured to align the synthesized vocal audio and the original vocal audio temporally based on the delay.
Example 15. The apparatus according to any one of Examples 10 to 14, further comprising:
a fifth determination module configured to determine dry audio of the original vocal audio based on the original vocal audio;
a sixth determination module configured to determine a left-right channel delay of the dry audio based on the dry audio; and
a third adjustment module configured to adjust stereo sound of the synthesized vocal audio based on the left-right channel delay.
Example 16. The apparatus according to any one of Examples 10 to 15, further comprising:
a seventh determination module configured to determine reverberant audio of the original vocal audio based on the original vocal audio;
an eighth determination module configured to determine reverberation parameters based on the reverberant audio, where the reverberation parameters indicate effects of the reverberant audio; and
a fourth adjustment module configured to adjust reverberation of the adjusted stereo sound of the synthesized vocal audio based on the reverberation parameters.
Example 17. The apparatus according to any one of Examples 10 to 16, further comprising:
a calibration module configured to globally calibrate the loudness of the synthesized vocal audio and the loudness of the vocal audio based on a predetermined threshold.
Example 18. The apparatus according to any one of Examples 10 to 17, further comprising:
an obtaining module configured to obtain original audio, where the original audio comprises the original vocal audio and accompaniment audio; and
a superimposition module configured to superimpose the accompaniment audio and the synthesized vocal audio whose loudness has been calibrated.
Example 19. An electronic device, comprising:
a processor; and
a memory coupled to the processor, where the memory has stored therein instructions that, when executed by the processor, cause the electronic device to perform actions comprising:
determining a first loudness curve of an original vocal audio and a second loudness curve of the synthesized vocal audio, where the original vocal audio is a wet audio, and the loudness curve indicates changes in an amplitude of sound over time;
adjusting the second loudness curve based on the first loudness curve; and
adjusting the loudness of the synthesized vocal audio based on an adjusted second loudness curve.
Example 20. The electronic device according to Example 19, where the determining a first loudness curve of an original vocal audio and a second loudness curve of the synthesized vocal audio comprises:
determining absolute amplitudes of the original vocal audio and the synthesized vocal audio;
fitting the absolute amplitudes of the original vocal audio and the synthesized vocal audio by using a polynomial; and
determining the first loudness curve and the second loudness curve based on the fitted absolute amplitudes of the original vocal audio and the synthesized vocal audio.
Example 21. The electronic device according to any one of Examples 19 to 20, where the adjusting the second loudness curve based on the first loudness curve comprises:
determining a gain factor based on the first loudness curve and the second loudness curve; and
adjusting the second loudness curve based on the gain factor.
Example 22. The electronic device according to any one of Examples 19 to 21, where the actions further comprise:
detecting silent segments of the original vocal audio and the synthesized vocal audio; and
adjusting the gain factor of the silent segment in response to detecting the silent segment.
Example 23. The electronic device according to any one of Examples 19 to 22, where the adjusting the loudness of the synthesized vocal audio based on an adjusted second loudness curve comprises:
determining a time delay between the original vocal audio and the synthesized vocal audio; and
aligning the synthesized vocal audio and the original vocal audio temporally based on the delay.
Example 24. The electronic device according to any one of Examples 19 to 23, where the actions further comprise:
determining dry audio of the original vocal audio based on the original vocal audio;
determining a left-right channel delay of the dry audio based on the dry audio; and
adjusting stereo sound of the synthesized vocal audio based on the left-right channel delay.
Example 25. The electronic device according to any one of Examples 19 to 24, where the actions further comprise:
determining reverberant audio of the original vocal audio based on the original vocal audio;
determining reverberation parameters based on the reverberant audio, wherein the reverberation parameters indicate effects of the reverberant audio; and
adjusting reverberation of the adjusted stereo sound of the synthesized vocal audio based on the reverberation parameters.
Example 26. The electronic device according to any one of Examples 19 to 25, where the actions further comprise:
globally calibrating the loudness of the synthesized vocal audio and the loudness of the vocal audio based on a predetermined threshold.
Example 27. The electronic device according to any one of Examples 19 to 26, where the actions further comprise:
obtaining original audio, where the original audio comprises the original vocal audio and accompaniment audio; and
superimposing the accompaniment audio and the synthesized vocal audio whose loudness has been calibrated.
Example 28. A computer-readable storage medium having stored thereon computer-executable instructions, where the computer-executable instructions are executed by a processor to implement the method according to any one of Examples 1 to 9.
Example 29. A computer program product tangibly stored on a computer-readable medium and comprising computer-executable instructions that, when executed by a device, cause the device to perform the method according to any one of Examples 1 to 9.

Although the present disclosure has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for adjusting the loudness of synthesized vocal audio, comprising:
determining a first loudness curve of original vocal audio and a second loudness curve of the synthesized vocal audio, wherein the original vocal audio is wet audio, and the loudness curves indicate changes in an amplitude of sound over time;
adjusting the second loudness curve based on the first loudness curve; and
adjusting the loudness of the synthesized vocal audio based on the adjusted second loudness curve.

2. The method according to claim 1, wherein the determining a first loudness curve of original vocal audio and a second loudness curve of the synthesized vocal audio comprises:
determining absolute amplitudes of the original vocal audio and the synthesized vocal audio;
fitting the absolute amplitudes of the original vocal audio and the synthesized vocal audio through a polynomial; and
determining the first loudness curve and the second loudness curve based on the fitted absolute amplitudes of the original vocal audio and the synthesized vocal audio.

3. The method according to claim 2, wherein the adjusting the second loudness curve based on the first loudness curve comprises:
determining a gain factor based on the first loudness curve and the second loudness curve; and
adjusting the second loudness curve based on the gain factor.

4. The method according to claim 3, further comprising:
detecting silent segments of the original vocal audio and the synthesized vocal audio; and
adjusting the gain factor of the silent segment in response to detecting the silent segment.

5. The method according to claim 4, wherein the adjusting the loudness of the synthesized vocal audio based on the adjusted second loudness curve comprises:
determining a time delay between the original vocal audio and the synthesized vocal audio; and
aligning the synthesized vocal audio and the original vocal audio temporally based on the delay.

6. The method according to claim 1, further comprising:
determining dry audio of the original vocal audio based on the original vocal audio;
determining a left-right channel delay of the dry audio based on the dry audio; and
adjusting stereo sound of the synthesized vocal audio based on the left-right channel delay.

7. The method according to claim 6, further comprising:
determining reverberant audio of the original vocal audio based on the original vocal audio;
determining reverberation parameters based on the reverberant audio, wherein the reverberation parameters indicate effects of the reverberant audio; and
adjusting reverberation of the adjusted stereo sound of the synthesized vocal audio based on the reverberation parameters.

8. The method according to claim 7, further comprising:
globally calibrating the loudness of the synthesized vocal audio based on a predetermined threshold.

9. The method according to claim 8, further comprising:
obtaining original audio, wherein the original audio comprises the original vocal audio and accompaniment audio; and
superimposing the accompaniment audio and the synthesized vocal audio whose loudness has been calibrated.

10. An electronic device, comprising:
a processor; and
a memory coupled to the processor, wherein the memory has stored therein instructions that, when executed by the processor, cause the electronic device to:
determine a first loudness curve of original vocal audio and a second loudness curve of the synthesized vocal audio, wherein the original vocal audio is wet audio, and the loudness curves indicate changes in an amplitude of sound over time;
adjust the second loudness curve based on the first loudness curve; and
adjust the loudness of the synthesized vocal audio based on the adjusted second loudness curve.

11. The device according to claim 10, wherein the instructions causing the processor to determine a first loudness curve of original vocal audio and a second loudness curve of the synthesized vocal audio comprise instructions causing the processor to:
determine absolute amplitudes of the original vocal audio and the synthesized vocal audio;
fit the absolute amplitudes of the original vocal audio and the synthesized vocal audio through a polynomial; and
determine the first loudness curve and the second loudness curve based on the fitted absolute amplitudes of the original vocal audio and the synthesized vocal audio.

12. The device according to claim 11, wherein the instructions causing the processor to adjust the second loudness curve based on the first loudness curve comprise instructions causing the processor to:
determine a gain factor based on the first loudness curve and the second loudness curve; and
adjust the second loudness curve based on the gain factor.

13. The device according to claim 12, further comprising instructions causing the processor to:
detect silent segments of the original vocal audio and the synthesized vocal audio; and
adjust the gain factor of the silent segment in response to detecting the silent segment.

14. The device according to claim 13, wherein the instructions cause the processor to adjusting the loudness of the synthesized vocal audio based on the adjusted second loudness curve comprise instructions causing the processor to:
determine a time delay between the original vocal audio and the synthesized vocal audio; and
align the synthesized vocal audio and the original vocal audio temporally based on the delay.

15. The device according to claim 10, further comprising instructions causing the processor to:
determine dry audio of the original vocal audio based on the original vocal audio;
determine a left-right channel delay of the dry audio based on the dry audio; and
adjust stereo sound of the synthesized vocal audio based on the left-right channel delay.

16. The device according to claim 15, further comprising instructions causing the processor to:
determine reverberant audio of the original vocal audio based on the original vocal audio;
determine reverberation parameters based on the reverberant audio, wherein the reverberation parameters indicate effects of the reverberant audio; and
adjust reverberation of the adjusted stereo sound of the synthesized vocal audio based on the reverberation parameters.

17. The device according to claim 16, further comprising instructions causing the processor to:
globally calibrate the loudness of the synthesized vocal audio based on a predetermined threshold.

18. The device according to claim 17, further comprising instructions causing the processor to:
obtain original audio, wherein the original audio comprises the original vocal audio and accompaniment audio; and
superimpose the accompaniment audio and the synthesized vocal audio whose loudness has been calibrated.

19. A non-transitory computer-readable medium comprising instructions stored thereon which, when executed by a processor, cause the processor to:
determine a first loudness curve of original vocal audio and a second loudness curve of the synthesized vocal audio, wherein the original vocal audio is wet audio, and the loudness curves indicate changes in an amplitude of sound over time;
adjust the second loudness curve based on the first loudness curve; and
adjust the loudness of the synthesized vocal audio based on the adjusted second loudness curve.

20. The non-transitory computer-readable medium according to claim 19, wherein the instructions causing the processor to determine a first loudness curve of original vocal audio and a second loudness curve of the synthesized vocal audio comprise instructions causing the processor to:
determine absolute amplitudes of the original vocal audio and the synthesized vocal audio;
fit the absolute amplitudes of the original vocal audio and the synthesized vocal audio through a polynomial; and
determine the first loudness curve and the second loudness curve based on the fitted absolute amplitudes of the original vocal audio and the synthesized vocal audio.
